(19) United States
(12) Patent Application Publication
(10) Pub. No.: US 2026/0254704 A1
(43) Pub. Date: Aug. 27, 2026

(54) APPARATUS AND METHOD FOR BIDIRECTIONAL VECTOR MODULATING

(71) Applicant: FOUNDATION OF SOONGSIL UNIVERSITY-INDUSTRY COOPERATION, Seoul (KR)

(72) Inventors: Jun Taek OH, Seoul (KR); Seong Ick JO, Seoul (KR)

(73) Assignee: FOUNDATION OF SOONGSIL UNIVERSITY-INDUSTRY COOPERATION, Seoul (KR)

(21) Appl. No.: 19/460,830

(22) Filed: Jan. 27, 2026

(30) Foreign Application Priority Data
Feb. 27, 2025 (KR) 10-2025-0025452

(51) Int. Cl. H04L 27/36; H04L 27/38

(52) U.S. Cl. CPC H04L 27/36; H04L 27/3809

(57) ABSTRACT

A bidirectional vector modulation apparatus capable of modulating vector signals transmitted in both directions is disclosed. The disclosed bidirectional vector modulation apparatus separates an input vector signal into a signal vector component and a carrier vector component, modulates the signal vector component and the carrier vector component respectively by activating or deactivating modulation circuits using current control, and then recombines the modulated components to generate a modulated vector signal.

The bidirectional vector modulation apparatus may be applied to communication devices or radar devices, and provides an advantage of enabling simplification and miniaturization of the modulator structure compared to conventional modulation apparatuses.

### CROSS-REFERENCE TO RELATED APPLICATION

This application claims priority from and the benefit of Korean Patent Application No. 10-2025-0025452 filed on Feb. 27, 2025, in the Korean Intellectual Property Office, the disclosure of which is incorporated herein by reference.

### BACKGROUND OF THE DISCLOSURE

### Field of the Disclosure

Example embodiments relate to a bidirectional vector modulation apparatus and method, and more particularly, to an apparatus and method configured to modulate vector signals transmitted in both directions by activating or deactivating modulation units.

This research was supported by the National Research Foundation of Korea (NRF) grant funded by the Korean government (Ministry of Science and ICT) (RS-2023-00218972). This work was also supported by IDEC through MPW and EDA tool services.

### Description of the Related Art

Vector modulation is a technique that modulates both the amplitude and phase of an input signal, and it is widely used not only in modern wired and wireless communication systems but also in radar systems.

In a vector modulation scheme, a signal vector (I) component and a carrier vector (Q) component having a phase difference of 90 degrees are individually generated, applied to variable-gain amplifiers to be attenuated or amplified, and then combined through a signal combining unit to generate a vector having a desired magnitude and phase.

Conventional vector modulation apparatuses require two vector modulation circuits for transmission and reception. Considering that both transmission and reception must be performed, three circuits—including a gain-variable circuit, a phase-variable circuit, and an attenuation circuit—must all be included, which results in an increase in system size.

There is an increasing demand for a more simplified bidirectional vector modulation apparatus to enable size reduction in communication devices or radar devices.

### SUMMARY

The technical problem addressed by the present invention is to modulate vector signals transmitted bidirectionally in accordance with the embodiments.

Another technical problem addressed by the present invention is to simplify and miniaturize the modulator so as to enable a more compact implementation of a radar transmit/receive unit.

According to an exemplary embodiment, a bidirectional vector modulation apparatus is disclosed, the apparatus comprising a first port configured to receive a first vector signal, a first signal separating/combining unit configured to separate the received first vector signal into a first signal vector component and a first carrier vector component, a first signal vector modulator configured to modulate the separated first signal vector component, a first carrier vector modulator configured to modulate the separated first carrier vector component, a second signal separating/combining unit configured to combine the modulated first signal vector component and the modulated first carrier vector component to generate a modulated first vector signal, a second port configured to output the modulated first vector signal, and a current controller configured to activate the first signal vector modulator and the first carrier vector modulator.

Here, the apparatus may further comprise a second signal vector modulator and a second carrier vector modulator, the second port may be configured to receive a second vector signal, the second signal separating/combining unit may be configured to separate the received second vector signal into a second signal vector component and a second carrier vector component, the current controller may be configured to deactivate the first signal vector modulator and the first carrier vector modulator and to activate the second signal vector modulator and the second carrier vector modulator, the second signal vector modulator may be configured to modulate the separated second signal vector component, the second carrier vector modulator may be configured to modulate the separated second carrier vector component, the first signal separating/combining unit may be configured to combine the modulated second signal vector component and the modulated second carrier vector component to generate a modulated second vector signal, and the first port may be configured to output the modulated second vector signal.

In addition, the first signal vector modulator, the first carrier vector modulator, the second signal vector modulator, and the second carrier vector modulator may each comprise at least one transistor, and the current controller may be configured to activate or deactivate the first signal vector modulator, the first carrier vector modulator, the second signal vector modulator, and the second carrier vector modulator by supplying or blocking a bias current of the transistors.

The apparatus may further comprise a gain controller configured to supply a control voltage to the transistors, and a modulation gain of the transistors may be determined according to the control voltage supplied to the transistors.

According to another exemplary embodiment, a bidirectional vector modulation method is disclosed, the method comprising receiving a first vector signal through a first port, separating the received first vector signal into a first signal vector component and a first carrier vector component, activating a first signal vector modulation circuit and a first carrier vector modulation circuit, modulating the separated first signal vector component using the activated first signal vector modulation circuit, modulating the separated first carrier vector component using the activated first carrier vector modulation circuit, combining the modulated first signal vector component and the modulated first carrier vector component to generate a modulated first vector signal, and outputting the modulated first vector signal through a second port.

Here, the method may further comprise receiving a second vector signal through the second port, separating the received second vector signal into a second signal vector component and a second carrier vector component, activating a second signal vector modulation circuit and a second carrier vector modulation circuit, modulating the separated second signal vector component using the activated second signal vector modulation circuit, modulating the separated second carrier vector component using the activated second carrier vector modulation circuit, combining the modulated second signal vector component and the modulated second carrier vector component to generate a modulated second vector signal, and outputting the modulated second vector signal through the first port.

The method may further comprise deactivating the first signal vector modulation circuit and the first carrier vector modulation circuit.

In addition, the first signal vector modulation circuit, the first carrier vector modulation circuit, the second signal vector modulation circuit, and the second carrier vector modulation circuit may each comprise at least one transistor, activating the second signal vector modulation circuit and the second carrier vector modulation circuit may comprise supplying a bias current to a transistor included in the second signal vector modulation circuit or the second carrier vector modulation circuit to activate the second signal vector modulation circuit or the second carrier vector modulation circuit, and deactivating the first signal vector modulation circuit and the first carrier vector modulation circuit may comprise blocking a bias current of a transistor included in the first signal vector modulation circuit or the first carrier vector modulation circuit to deactivate the first signal vector modulation circuit or the first carrier vector modulation circuit.

The method may further comprise supplying a control voltage to the transistors, and a modulation gain of the transistors may be determined according to the control voltage.

According to the present invention, vector signals transmitted in both directions can be modulated.

According to the present invention, the modulator can be simplified and miniaturized, thereby enabling a more compact implementation of a radar transmit/receive unit

### BRIEF DESCRIPTION OF THE FIGURES

Embodiments will be described in more detail with regard to the figures, wherein like reference numerals refer to like parts throughout the various figures unless otherwise specified, and wherein:

FIG. 1 is a diagram schematically illustrating a structure of a bidirectional vector modulation apparatus according to an exemplary embodiment.

FIG. 2 is a block diagram illustrating the structure of a bidirectional vector modulation apparatus according to an exemplary embodiment.

FIG. 3 is a diagram illustrating a bidirectional vector modulation apparatus in which a first signal vector modulator and a first carrier vector modulator are activated according to a first exemplary embodiment.

FIG. 4 is a diagram illustrating a bidirectional vector modulation apparatus in which a second signal vector modulator and a second carrier vector modulator are activated according to another exemplary embodiment.

FIG. 5 is a diagram illustrating a principle of forming a signal vector.

FIG. 6 is a diagram illustrating a principle of forming a carrier vector.

FIG. 7 is a diagram illustrating a principle of forming a vector signal.

FIG. 8 is a diagram sequentially illustrating a bidirectional vector modulation method according to an exemplary embodiment.

### DETAILED DESCRIPTION OF THE DISCLOSURE

The structural or functional descriptions provided herein are merely illustrative for explaining exemplary embodiments according to the concept of the present invention, and the embodiments according to the concept of the present invention may be implemented in various forms and are not limited to the embodiments described in this specification. The embodiments according to the concept of the present invention may be subjected to various modifications and may take on various forms, and therefore the embodiments will be illustrated in the drawings and described in detail in this specification. However, this is not intended to limit the embodiments according to the concept of the present invention to any specific mode of disclosure, but is intended to include modifications, equivalents, or substitutes that fall within the spirit and scope of the present invention.

Terms such as first and second may be used to describe various components, but the components should not be limited by such terms. The terms are only used to distinguish one component from another, and, for example, without departing from the scope of the concept of the present invention, a first component may be referred to as a second component and similarly a second component may be referred to as a first component.

When a component is referred to as being “connected to” or “coupled to” another component, it should be understood that the component may be directly connected or coupled to the other component, but other components may be present therebetween. In contrast, when a component is referred to as being “directly connected to” or “directly coupled to” another component, it should be understood that no other components are present therebetween. Expressions describing relationships between components, such as “between,” “directly between,” or “directly adjacent to,” should be interpreted in the same manner.

The terminology used in this specification is for the purpose of describing particular embodiments only and is not intended to limit the present invention. As used herein, the singular forms include the plural forms unless clearly indicated otherwise by the context. In this specification, terms such as “include,” “comprise,” or “have” are intended to specify the presence of stated features, integers, steps, operations, elements, or components, or combinations thereof, and should not be construed as precluding the presence or addition of one or more other features, integers, steps, operations, elements, components, or combinations thereof.

Unless otherwise defined, all terms used herein, including technical and scientific terms, have the same meaning as commonly understood by one of ordinary skill in the art to which the present invention pertains. Terms that are defined in commonly used dictionaries should be interpreted consistently with their meaning in the relevant technical context and should not be interpreted in an idealized or overly formal manner unless explicitly defined otherwise in this specification.

Hereinafter, exemplary embodiments will be described in detail with reference to the accompanying drawings. However, the scope of the patent application is not limited or restricted by such embodiments. The same reference numerals provided in the drawings denote the same elements.

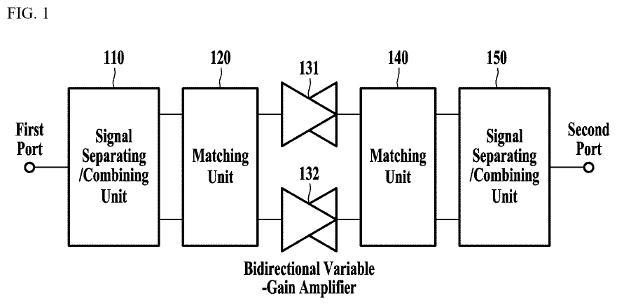

FIG. 1 is a diagram schematically illustrating a structure of a bidirectional vector modulation apparatus according to an exemplary embodiment.

The bidirectional vector modulation apparatus according to an exemplary embodiment includes a signal separating/combining unit 110, matching units 120 and 140, bidirectional variable-gain amplifiers 131 and 132, and a signal separating/combining unit 150.

The bidirectional vector modulation apparatus illustrated in FIG. 1 receives a first signal through a first port. The received first signal may be in a complex form. In this case, the signal separating/combining unit 110 may separate a real part and an imaginary part of the first signal into a first signal vector component and a first carrier vector component.

The matching units 120 and 140 are used to perform impedance matching between the signal separating/combining unit 110 and the bidirectional variable-gain amplifiers 131 and 132. In one aspect, the matching units may be implemented using components such as a transformer or a balun.

The bidirectional variable-gain amplifiers 131 and 132 modulate and amplify the first signal vector component and the first carrier vector component matched by the matching unit 120.

The signal separating/combining unit 150 combines the first signal vector component and the first carrier vector component that have been matched by the matching unit 140 to generate a modulated first signal. The modulated first signal may be output through a second port.

The bidirectional vector modulation apparatus may receive a second signal through the second port. In this case as well, the bidirectional vector modulation apparatus may separate the second signal into a second signal vector component and a second carrier vector component using the signal separating/combining unit 150, the matching unit 140, the bidirectional variable-gain amplifiers 131 and 132, the matching unit 120, and the signal separating/combining unit 110, may modulate and amplify the separated components, and may generate a modulated second signal.

The bidirectional vector modulation apparatus illustrated in FIG. 1 may amplify and modulate a signal input through the first port and output the signal through the second port, and may also amplify and modulate a signal input through the second port and output the signal through the first port.

The bidirectional vector modulation apparatus illustrated in FIG. 1 can implement a communication device or a radar transmit/receive unit in a simple and compact manner, and is expected to provide significant benefits particularly when applied to a TDD (Time Division Duplex) communication system.

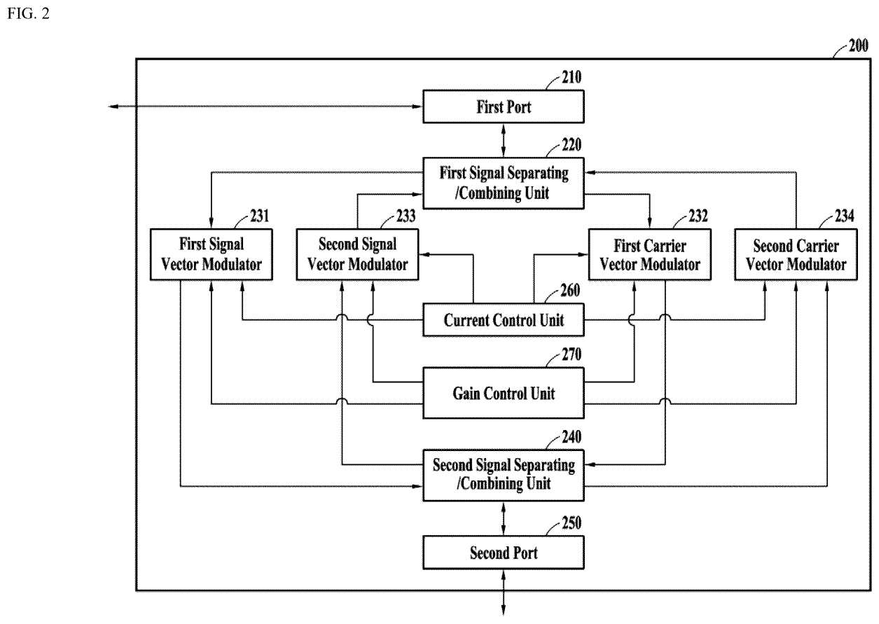

FIG. 2 is a block diagram illustrating a structure of a bidirectional vector modulation apparatus according to an exemplary embodiment.

The bidirectional vector modulation apparatus 200 according to an exemplary embodiment includes a first port 210, a first signal separating/combining unit 220, a first signal vector modulator 231, a first carrier vector modulator 232, a second signal vector modulator 233, a second carrier vector modulator 234, a current controller 260, a gain controller 270, a second signal separating/combining unit 240, and a second port 250.

The first port 210 is configured to receive a first vector signal. In one aspect, the first vector signal may be a complex signal having a real part and an imaginary part.

The first signal separating/combining unit 220 may separate the received first vector signal into a first signal vector component and a first carrier vector component. For example, the first signal separating/combining unit 220 may separate a real part of the received first vector signal as the first signal vector component and may separate an imaginary part of the first vector signal as the first carrier vector component.

The current controller 260 may activate the first signal vector modulator 231 and the first carrier vector modulator 232, and may deactivate the second signal vector modulator 233 and the second carrier vector modulator 234.

The first signal vector modulator 231 modulates the separated first signal vector component.

The first carrier vector modulator 232 modulates the separated first carrier vector component.

In one aspect, the first signal vector modulator 231, the first carrier vector modulator 232, the second signal vector modulator 233, and the second carrier vector modulator 234 may each comprise at least one transistor. In this case, the current controller 260 may activate the first signal vector modulator 231 and the first carrier vector modulator 232 by supplying a bias current to transistors included in the first signal vector modulator 231 and the first carrier vector modulator 232. In addition, the current controller 260 may deactivate the second signal vector modulator 233 and the second carrier vector modulator 234 by blocking a bias current of transistors included in the second signal vector modulator 233 and the second carrier vector modulator 234.

The second signal separating/combining unit 240 combines the modulated first signal vector component and the modulated first carrier vector component to generate a modulated first vector signal.

The second port 250 outputs the modulated first vector signal.

The bidirectional vector modulation apparatus 200 may operate even when a transmission/reception direction of a signal is changed.

In this case, the second port 250 receives a second vector signal. In one aspect, the second vector signal may be a complex signal having a real part and an imaginary part.

The second signal separating/combining unit 240 may separate the received second vector signal into a second signal vector component and a second carrier vector component. For example, the second signal separating/combining unit 240 may separate a real part of the received second vector signal as the second signal vector component and may separate an imaginary part of the second vector signal as the second carrier vector component.

The current controller 260 may activate the second signal vector modulator 233 and the second carrier vector modulator 234, and may deactivate the first signal vector modulator 231 and the first carrier vector modulator 232. In one aspect, the current controller 260 may activate the second signal vector modulator 233 and the second carrier vector modulator 234 by supplying a bias current to transistors included in the second signal vector modulator 233 and the second carrier vector modulator 234. In addition, the current controller 260 may deactivate the first signal vector modulator 231 and the first carrier vector modulator 232 by blocking a bias current of transistors included in the first signal vector modulator 231 and the first carrier vector modulator 232.

The second signal vector modulator 233 modulates the separated second signal vector component.

The second carrier vector modulator 234 modulates the separated second carrier vector component.

The first signal separating/combining unit 220 combines the modulated second signal vector component and the modulated second carrier vector component to generate a modulated second vector signal.

The first port 210 outputs the modulated second vector signal.

The gain controller 270 may control a modulation gain of the first signal vector modulator 231, the first carrier vector modulator 232, the second signal vector modulator 233, and the second carrier vector modulator 234. In one aspect, the gain controller 270 supplies a control voltage to transistors included in the first signal vector modulator 231, the first carrier vector modulator 232, the second signal vector modulator 233, and the second carrier vector modulator 234, and a modulation gain of the transistors may be determined according to the control voltage.

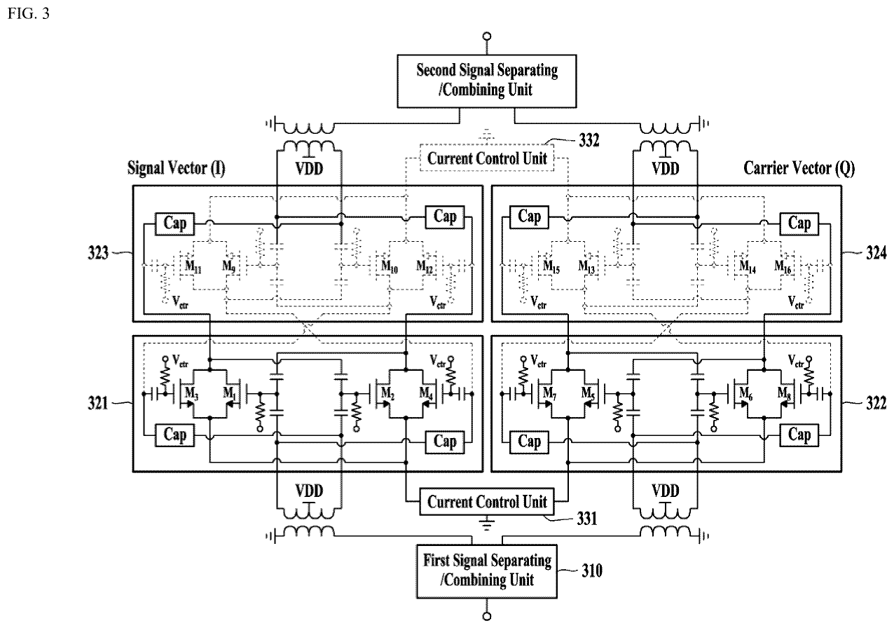

FIG. 3 is a diagram illustrating a bidirectional vector modulation apparatus in which a first signal vector modulator and a first carrier vector modulator are activated according to a first exemplary embodiment.

The first signal separating/combining unit 310 separates a received first vector signal into a first signal vector component and a first carrier vector component.

The current controller 331 may activate the first signal vector modulator 321 and the first carrier vector modulator 322 by supplying a bias current to transistors included in the first signal vector modulator 321 and the first carrier vector modulator 322.

In addition, the current controller 332 may deactivate the second signal vector modulator 323 and the second carrier vector modulator 324 by blocking a bias current of transistors included in the second signal vector modulator 323 and the second carrier vector modulator 324.

The second signal separating/combining unit 340 combines the first signal vector component modulated by the first signal vector modulator 321 and the first carrier vector component modulated by the first carrier vector modulator 322 to generate a modulated first vector signal.

The modulated first vector signal is output through the second port.

In FIG. 3, “Cap” disposed in the middle of the circuit compensates for parasitic capacitance components of the transistors and serves to reduce gain errors during gain variation.

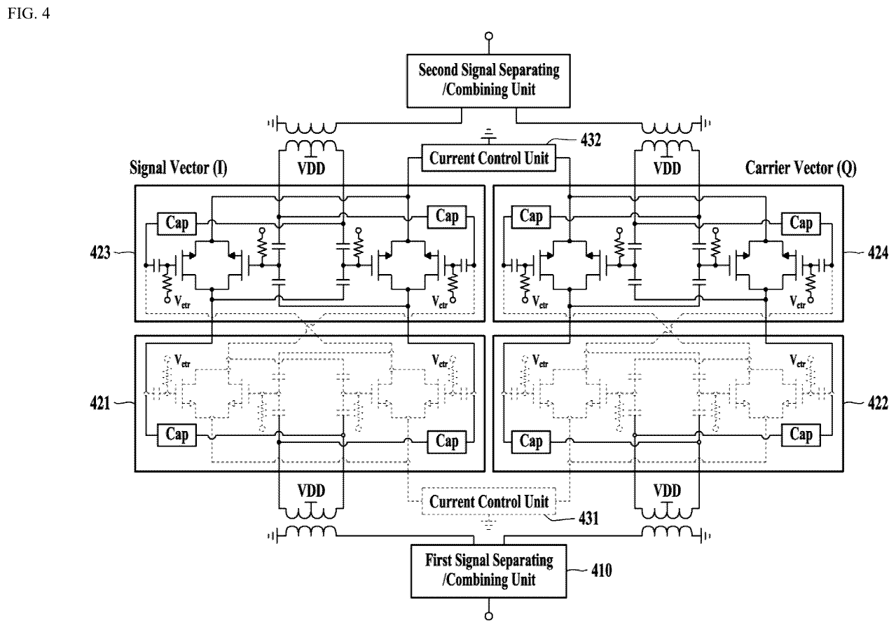

FIG. 4 is a diagram illustrating a bidirectional vector modulation apparatus in which a second signal vector modulator and a second carrier vector modulator are activated according to another exemplary embodiment.

The circuit illustrated in FIG. 4 is identical to the circuit illustrated in FIG. 3, except that the first signal vector modulator 421 and the first carrier vector modulator 422 are deactivated, and the second signal vector modulator 423 and the second carrier vector modulator 424 are activated.

The second signal separating/combining unit 440 separates a received second vector signal into a second signal vector component and a second carrier vector component.

The current controller 432 may activate the second signal vector modulator 423 and the second carrier vector modulator 424 by supplying a bias current to transistors included in the second signal vector modulator 423 and the second carrier vector modulator 424.

In addition, the current controller 431 may deactivate the first signal vector modulator 421 and the first carrier vector modulator 422 by blocking a bias current of transistors included in the first signal vector modulator 421 and the first carrier vector modulator 422.

The first signal separating/combining unit 410 combines the second signal vector component modulated by the second signal vector modulator 423 and the second carrier vector component modulated by the second carrier vector modulator 424 to generate a modulated second vector signal.

The modulated second vector signal is output through the first port.

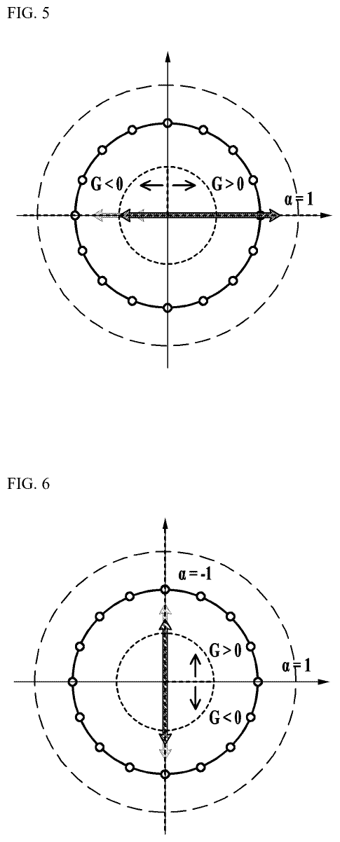

FIG. 5 is a diagram illustrating a principle of forming a signal vector.

The signal vector corresponds to a real part among components of a vector signal. The modulation gain of transistors included in the first signal vector modulator 231 and the second signal vector modulator 233 is controlled according to a control voltage supplied by the gain controller 270.

A magnitude of the signal vector may vary from a maximum value (M) to a minimum value (−M) depending on the modulation gain of the transistors.

FIG. 6 is a diagram illustrating a principle of forming a carrier vector.

The carrier vector corresponds to an imaginary part among components of a vector signal. A modulation gain of transistors included in the first carrier vector modulator 232 and the second carrier vector modulator 234 is controlled according to a control voltage supplied by the gain controller 270.

A magnitude of the carrier vector may vary from a maximum value (M) to a minimum value (−M) depending on the modulation gain of the transistors.

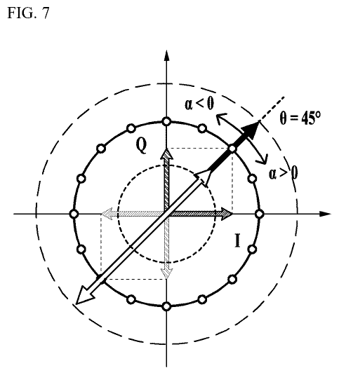

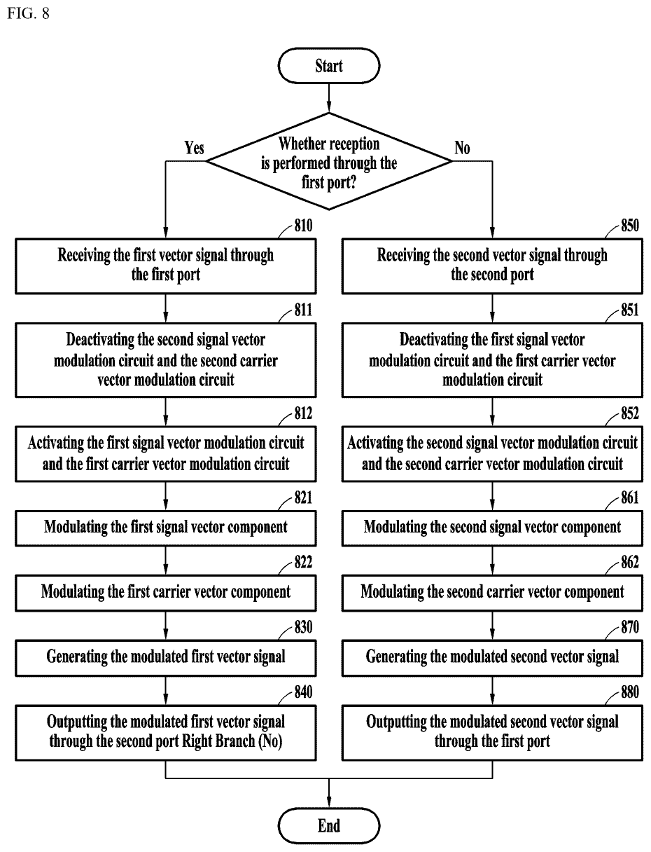

FIG. 7 is a diagram illustrating a principle of forming a vector signal.

A vector signal may be generated by combining a signal vector corresponding to a real part and a carrier vector corresponding to an imaginary part, and may be generated in accordance with Equation 1.

$${I}_{I} = \frac{1}{2} {MG}_{I} ( 1 + α ) \qquad [ Equation 1 ]$$

$${I}_{Q} = \frac{1}{2} {MG}_{Q} ( 1 - α )$$

$$- 1 \leq α \leq 1 ,$$

$$- 1 \leq {G}_{I , Q} \leq 1$$

Here, I_{I} denotes a signal vector, I_{Q} denotes a carrier vector, and M denotes a maximum output amplitude of a transistor. G_{I} denotes a normalized modulation gain of the first signal vector modulator 231 or the second signal vector modulator 233, and G_{Q} denotes a normalized modulation gain of the first carrier vector modulator 232 or the second carrier vector modulator 234.

α denotes a normalized value representing a phase of a vector signal. When α=1, only the signal vector is generated, and when α=−1, only the carrier vector is generated.

In addition, when α=0.5 and G_{I} and G_{Q} have identical positive values, the vector signal corresponds to a first-quadrant vector.

Furthermore, when α=0.5 and G_{I} and G_{Q} have identical negative values, the vector signal corresponds to a third-quadrant vector.

Using the above relation, vectors in all quadrants may be formed within a range of

$$- 1 \leq α \leq 1 ,$$

$$- 1 \leq {G}_{I , Q} \leq 1$$

FIG. 8 is a diagram sequentially illustrating a bidirectional vector modulation method according to an exemplary embodiment.

In one aspect, the bidirectional vector modulation apparatus may operate to modulate a first vector signal input through the first port and output the modulated first vector signal through the second port over time, or may operate to modulate a second vector signal input through the second port and output the modulated second vector signal through the first port.

In step 801, the bidirectional vector modulation apparatus determines whether a first vector signal is received through the first port.

In step 810, the bidirectional vector modulation apparatus receives the first vector signal through the first port.

The bidirectional vector modulation apparatus separates the received first vector signal into a first signal vector component and a first carrier vector component.

In step 811, the bidirectional vector modulation apparatus deactivates the second signal vector modulation circuit and the second carrier vector modulation circuit.

In step 812, the bidirectional vector modulation apparatus activates the first signal vector modulation circuit and the first carrier vector modulation circuit.

In one aspect, the first signal vector modulation circuit, the first carrier vector modulation circuit, the second signal vector modulation circuit, and the second carrier vector modulation circuit may each comprise at least one transistor.

The step of activating the first signal vector modulation circuit and the first carrier vector modulation circuit may include activating the first signal vector modulation circuit or the first carrier vector modulation circuit by supplying a bias current to a transistor included in the first signal vector modulation circuit or the first carrier vector modulation circuit.

In addition, the step of deactivating the second signal vector modulation circuit and the second carrier vector modulation circuit may include deactivating the second signal vector modulation circuit or the second carrier vector modulation circuit by blocking a bias current of a transistor included in the second signal vector modulation circuit or the second carrier vector modulation circuit.

The bidirectional vector modulation apparatus may supply a control voltage to transistors included in the first signal vector modulation circuit, the first carrier vector modulation circuit, the second signal vector modulation circuit, and the second carrier vector modulation circuit.

In step 821, the bidirectional vector modulation apparatus modulates the first signal vector component using the activated first signal vector modulation circuit. A modulation gain of a transistor included in the first signal vector modulation circuit may be determined according to a control voltage of the transistor.

In step 822, the bidirectional vector modulation apparatus modulates the first carrier vector component using the activated first carrier vector modulation circuit. A modulation gain of a transistor included in the first carrier vector modulation circuit may be determined according to a control voltage of the transistor.

In step 830, the bidirectional vector modulation apparatus combines the modulated first signal vector component and the modulated first carrier vector component to generate a modulated first vector signal.

In step 840, the bidirectional vector modulation apparatus outputs the modulated first vector signal through the second port.

In step 850, the bidirectional vector modulation apparatus receives a second vector signal through the second port.

The bidirectional vector modulation apparatus separates the received second vector signal into a second signal vector component and a second carrier vector component.

In step 851, the bidirectional vector modulation apparatus deactivates the first signal vector modulation circuit and the first carrier vector modulation circuit.

In step 852, the bidirectional vector modulation apparatus activates the second signal vector modulation circuit and the second carrier vector modulation circuit.

In one aspect, the first signal vector modulation circuit, the first carrier vector modulation circuit, the second signal vector modulation circuit, and the second carrier vector modulation circuit may each comprise at least one transistor.

The step of activating the second signal vector modulation circuit and the second carrier vector modulation circuit may include activating the second signal vector modulation circuit or the second carrier vector modulation circuit by supplying a bias current to a transistor included in the second signal vector modulation circuit or the second carrier vector modulation circuit.

In addition, the step of deactivating the first signal vector modulation circuit and the first carrier vector modulation circuit may include deactivating the first signal vector modulation circuit or the first carrier vector modulation circuit by blocking a bias current of a transistor included in the first signal vector modulation circuit or the first carrier vector modulation circuit.

The bidirectional vector modulation apparatus may supply a control voltage to transistors included in the first signal vector modulation circuit, the first carrier vector modulation circuit, the second signal vector modulation circuit, and the second carrier vector modulation circuit.

In step 861, the bidirectional vector modulation apparatus modulates the second signal vector component using the activated second signal vector modulation circuit. A modulation gain of a transistor included in the second signal vector modulation circuit may be determined according to a control voltage of the transistor.

In step 862, the bidirectional vector modulation apparatus modulates the second carrier vector component using the activated second carrier vector modulation circuit. A modulation gain of a transistor included in the second carrier vector modulation circuit may be determined according to a control voltage of the transistor.

In step 870, the bidirectional vector modulation apparatus combines the modulated second signal vector component and the modulated second carrier vector component to generate a modulated second vector signal.

In step 880, the bidirectional vector modulation apparatus outputs the modulated second vector signal through the first port.

The apparatus described above may be implemented using hardware components, software components, and/or a combination of hardware and software components. For example, the apparatus and components described in the embodiments may be implemented using one or more general-purpose computers or special-purpose computers that can execute and respond to instructions, such as a processor, a controller, an arithmetic logic unit (ALU), a digital signal processor (DSP), a microcomputer, an FPA (field programmable array), a PLU (programmable logic unit), a microprocessor, or any other device capable of executing instructions.

The processing device may execute an operating system (OS) and one or more software applications running on the operating system. In addition, the processing device may access, store, manipulate, process, and generate data in response to execution of software. For convenience of explanation, a processing device may be described as being implemented by a single unit; however, it will be understood by those skilled in the art that the processing device may include multiple processing elements and/or multiple types of processing elements. For example, the processing device may include multiple processors, or may include one processor and one controller. Other processing configurations, such as a parallel processor, are also possible.

Software may include a computer program, code, instructions, or one or more combinations thereof, and may configure a processing device to operate in a desired manner or may instruct the processing device individually or collectively. Software and/or data may be embodied permanently or temporarily in any type of machine, component, physical device, virtual equipment, computer-readable storage medium or device, or transmitted signal wave, to be interpreted by the processing device or to provide instructions or data to the processing device.

Software may also be distributed over a networked computer system, stored or executed in a distributed manner. Software and data may be stored in one or more computer-readable recording media.

A method according to an embodiment may be implemented in the form of program instructions that may be executed through various computer means and recorded on a computer-readable medium. The computer-readable medium may include program instructions, data files, data structures, or combinations thereof. The program instructions recorded on the medium may be specially designed and configured for the embodiments, or may be known and available to those skilled in computer software.

Examples of computer-readable recording media include magnetic media such as hard disks, floppy disks, and magnetic tapes; optical media such as CD-ROMs and DVDs; magneto-optical media such as floptical disks; and hardware devices specially configured to store and execute program instructions such as ROM, RAM, and flash memory.

Examples of program instructions include machine code generated by a compiler, as well as high-level language code that may be executed by a computer using an interpreter or the like. The above-described hardware devices may be configured to operate as one or more software modules to perform the operations of the embodiments, and vice versa.

Although the embodiments have been described with reference to limited drawings, various modifications and variations may be made based on the above description by those skilled in the art. For example, the described techniques may be performed in an order different from that described, and/or the components of the described systems, structures, apparatuses, or circuits may be combined or arranged in different ways, or replaced or substituted with other components or equivalents to achieve appropriate results.

Accordingly, other implementations, other embodiments, and equivalents to the claims are within the scope of the claims that follow.

What is claimed is:

1. A bidirectional vector modulation apparatus comprising:
a first port configured to receive a first vector signal;
a first signal separating/combining unit configured to separate the received first vector signal into a first signal vector component and a first carrier vector component;
a first signal vector modulator configured to modulate the separated first signal vector component;
a first carrier vector modulator configured to modulate the separated first carrier vector component;
a second signal separating/combining unit configured to combine the modulated first signal vector component and the modulated first carrier vector component to generate a modulated first vector signal;
a second port configured to output the modulated first vector signal; and
a current controller configured to activate the first signal vector modulator and the first carrier vector modulator.

2. The bidirectional vector modulation apparatus of claim 1, further comprising:
a second signal vector modulator; and
a second carrier vector modulator,
wherein the second port is further configured to receive a second vector signal,
wherein the second signal separating/combining unit is further configured to separate the received second vector signal into a second signal vector component and a second carrier vector component,
wherein the current controller is configured to deactivate the first signal vector modulator and the first carrier vector modulator, and to activate the second signal vector modulator and the second carrier vector modulator,
wherein the second signal vector modulator is configured to modulate the separated second signal vector component,
wherein the second carrier vector modulator is configured to modulate the separated second carrier vector component,
wherein the first signal separating/combining unit is configured to combine the modulated second signal vector component and the modulated second carrier vector component to generate a modulated second vector signal, and
wherein the first port is configured to output the modulated second vector signal.

3. The bidirectional vector modulation apparatus of claim 2,
wherein the first signal vector modulator, the first carrier vector modulator, the second signal vector modulator, and the second carrier vector modulator each comprise at least one transistor, and
wherein the current controller is configured to activate or deactivate the first signal vector modulator, the first carrier vector modulator, the second signal vector modulator, and the second carrier vector modulator by supplying or blocking a bias current of the transistors.

4. The bidirectional vector modulation apparatus of claim 3, further comprising:
a gain controller configured to supply a control voltage to the transistors,
wherein a modulation gain of the transistors is determined according to the control voltage supplied to the transistors.

5. A bidirectional vector modulation method comprising:
receiving a first vector signal through a first port;
separating the received first vector signal into a first signal vector component and a first carrier vector component;
activating a first signal vector modulation circuit and a first carrier vector modulation circuit;
modulating the separated first signal vector component using the activated first signal vector modulation circuit;
modulating the separated first carrier vector component using the activated first carrier vector modulation circuit;
combining the modulated first signal vector component and the modulated first carrier vector component to generate a modulated first vector signal; and
outputting the modulated first vector signal through a second port.

6. The bidirectional vector modulation method of claim 5, further comprising:
receiving a second vector signal through the second port;
separating the received second vector signal into a second signal vector component and a second carrier vector component;
activating a second signal vector modulation circuit and a second carrier vector modulation circuit;
modulating the separated second signal vector component using the activated second signal vector modulation circuit;
modulating the separated second carrier vector component using the activated second carrier vector modulation circuit;
combining the modulated second signal vector component and the modulated second carrier vector component to generate a modulated second vector signal; and
outputting the modulated second vector signal through the first port.

7. The bidirectional vector modulation method of claim 6, further comprising:
deactivating the first signal vector modulation circuit and the first carrier vector modulation circuit.

8. The bidirectional vector modulation method of claim 6,
wherein the first signal vector modulation circuit, the first carrier vector modulation circuit, the second signal vector modulation circuit, and the second carrier vector modulation circuit each comprise at least one transistor,
wherein activating the second signal vector modulation circuit and the second carrier vector modulation circuit comprises supplying a bias current to a transistor included in the second signal vector modulation circuit or the second carrier vector modulation circuit to activate the second signal vector modulation circuit or the second carrier vector modulation circuit, and
wherein deactivating the first signal vector modulation circuit and the first carrier vector modulation circuit comprises blocking a bias current of a transistor included in the first signal vector modulation circuit or the first carrier vector modulation circuit to deactivate the first signal vector modulation circuit or the first carrier vector modulation circuit.

9. The bidirectional vector modulation method of claim 8, further comprising:
supplying a control voltage to the transistors,
wherein a modulation gain of the transistors is determined according to the control voltage.
